(19) United States
(12) Patent Application Publication
(10) Pub. No.: US 2008/0068784 A1
(43) Pub. Date: Mar. 20, 2008

(54) Moveable Display Mount

(76) Inventor: Michael F. Bouissiere, Yorba Linda, CA (US)

Correspondence Address: Altera Law Group, LLC, 220 S 6 St Suite 1700, Minneapolis, MN, 55402, US

(21) Appl. No.: 11/856,355

(22) Filed: Sep. 17, 2007

Related U.S. Application Data
(60) Provisional application No. 60/845,134, filed on Sep. 15, 2006.

(51) Int. Cl. G06F 1/16

(52) U.S. Cl. 361/681

(57) ABSTRACT

A system and method of moveably mounting a device, usually flat panel display to a base bracket, is disclosed. The system provides for two types of movement: translational (up/down) along rods (122, 124) and rotational on pivot (340). The gap (296) in unit (160/162) prevents elements (180/182) from twisting under torsion forces caused by display's center of gravity imbalance.

### CROSS-REFERENCE TO RELATED APPLICATION

The present application claims the benefit of U.S. Provisional Application Ser. No. 60/845,134 filed on 15 Sep. 2006, the complete subject matter of which is hereby incorporated herein by reference in its entirety.

### FIELD OF THE INVENTION

The present invention is directed generally to supporting structures for mounting devices, such as displays, such as flat panel displays.

### BACKGROUND

Moveable mounts have been available in many forms. A common type of one which mounts on a wall and extends away therefrom. Another type is a floor or table top mount. Typically such mounts are used for displays, commonly flat panel displays. Such displays have ever growing planar surface areas and thus becoming heavier, but at the same time, are ever more subject to damage from twisting (torquing) motion.

Adjusting the position of such large displays by moving their base is becoming problematic because of weight and size issues. Therefore, finding a way to adjust the viewing angle and height without causing torque on the display or having to move the base and carry ever increasing loads, needs to be solved. Furthermore, ease of assembly, ease of adjustability and strength need to be combined.

### SUMMARY OF THE INVENTION

Generally, the present invention relates to system and method for movably mounting a device to a bracket having, a first unit configured to be slideably attached to the bracket; said unit having pivot point on its surfaces; and a second unit configured to be pivotally attached to the surface; said second unit including a planar section for attachment to the device on one surface and a protrusion extending from the unit on its opposite surface, said protrusion being pivotally connected to said first unit so that said second unit may rotate with respect to the first unit on said pivot.

In another embodiment, a mounting bracket for rotatably mounting a device to a support structure, has a first unit configured to be slideably attached to the support structure; having a pair of substantially planar plates spaced apart a predetermined distance defining a gap, and having a pivot aperture in both of said plates, such that a pivot axis is defined running thru said apertures; and a second unit to be attached to the device, having a substantially planar portion of thickness of not greater than said predetermined distance and configured to be at least partially received between said plates and having an aperture alignable with said pivot apertures and said pivot axis, and configured to be pivotally attached to the surface; so that said second unit may rotate with respect to the first unit on said pivot and while said second unit is substantially prevented from twisting by being captured between said plates of said first unit.

In another embodiment, the portion of the second unit which is received within said gap generally fills the gap, so that said second unit remains substantially parallel to said plates of said first unit and thereby resists twisting forces between said units.

In another embodiment, the first unit has an aperture sized to at least receive said bracket and being slideable generally orthogonally with respect to said bracket; and having pivot point on said first unit; and a second unit for supporting the device by attachment thereto, and being pivotally attachable said first unit; said second unit including a section for attachment to the device on one surface and said pivot opposite the section for attachment.

In another embodiment, the first unit includes a user engageable lock to fix the position of the first unit relative to the bracket.

In another embodiment, said second unit includes a pair of generally parallel plates with a gap therebetween, and wherein said second unit is at least partially received within the said gap.

In another embodiment, a portion of the second unit is received within said gap which generally fills the gap, so that said second unit remains largely parallel to said plates of said first unit and thereby resists torquing forces between said units.

In another embodiment, there is an aperture passing thru said first and second plates and wherein said pivoting portion of said second unit includes a like aperture thereby forming a pivot axis through said apertures.

In another embodiment, there are at least two pairs of first and second units slideably spaced apart along said bracket to support said device at least two locations.

In another embodiment, the plates are joined by a back plate and wherein said back plate includes at least one slide lock to selectively lock said unit to a fixed position on the bracket.

In another embodiment, a display unit has a generally planar back panel to a rod-like bracket, with a first unit having a pair of spaced apart plates defining a gap therebetween, each plate having an aperture sized to at least receive said bracket and being slideable generally orthogonally with respect to said bracket; said unit including a pivot point; and a second unit for supporting the display by attachment thereto, and being pivotally attachable said first unit; said second unit including a section for attachment to the device on one surface and a portion of the second unit including a pivot opposite the section for attachment to said first unit, said portion being sized to be received within said gap and configured to largely prevent torquing movement between said first and second movement by virtue of the confinement within said gap.

In another embodiment the bracket includes at least two generally parallel poles and wherein said first unit includes at least two apertures to slideably receive said poles.

In another embodiment, the apertures in said plates are lined by friction retainers interposed between said bracket and said plates.

In another embodiment, the friction retainers are slightly larger than the gap between the plates and the bracket.

In another embodiment, the retainers include a resilient material.

In another embodiment, a method of providing a display on a longitudinal bracket for translational and rotational movement is described comprising the steps of: mounting a first unit to the display, the first unit having a recess with spaced apart walls parallel planes and defining a gap between the walls, mounting a second unit in slideable relationship with the bracket; capturing at least a portion of the second unit within the gap of the first unit; so that said units are largely prevented from torquing motion relative to each other.

In another embodiment, there is disclosed a system for rotatably supporting an attachable device having a support structure comprising at least one elongated brackets; a first unit configured to be slideably attached to the support structure; having a pair of substantially planar plates spaced apart a predetermined distance defining a gap, and having a pivot aperture in both of said plates, such that a pivot axis is defined running thru said apertures; and a second unit to be attached to the device, having a substantially planar portion of thickness of not greater than said predetermined distance and configured to be at least partially received between said plates and having an aperture alignable with said pivot apertures and said pivot axis, a configured to be pivotally attached to the surface; so that said second unit may rotate with respect to the first unit on said pivot and while said second unit is substantially prevented from twisting by being captured between said plates of said first unit.

In another embodiment, there is also disclosed a method of mounting a display device on a longitudinal bracket for translational and rotational movement having the steps of, mounting a first unit to the bracket in a slideable relationship therewith the bracket, the first unit having a recess with spaced part walls in parallel plans and defining a gap between the walls, mounting a second unit in rotatable relationship with the first unit; said second unit having a portion with spaced part planar walls; capturing at least a portion of the second unit within the gap of the first unit; and attaching a device to said second unit.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of one embodiment of the mount with a base and table;

FIG. 2 is a front plan view of FIG. 1;

FIG. 3 is a side plan view FIG. 1:

FIG. 4 is a top plan view of FIG. 1;

FIG. 5 is an exploded perspective view of the embodiment in FIG. 1;

FIG. 6 is a perspective view of the portion of the mount typically attached between the floor mounted bracket and the display unit;

FIG. 7 is an exploded view of FIG. 6;

FIG. 8 is a perspective view of a mounting unit;

FIG. 9 is a perspective from the other side of FIG. 8;

FIG. 10 is a top plan view of the subject in FIG. 9;

FIG. 11 is a side plan view of the subject of FIG. 9 showing locking screws; and

FIG. 12 is a perspective view of a panel mount unit.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

In general, the present invention is directed to supporting structures for devices (and methods of making and using such structures), more particularly for mounting a display to a mounting bracket. The preferred embodiments of the invention provide a convenient method for both attaching, rotating, translating and disengaging a display, for example from a fixed mount such as a stand without disassembly or movement of the base bracket.

It is important to keep in mind that while reference is made to displays, stands, vertical mounts, etc., these are only preferred embodiments but the invention has much broader application. These terms like “display” are used for convenience but should be understood to include a broad range of devices which do not “display” but need to be supported and articulated.

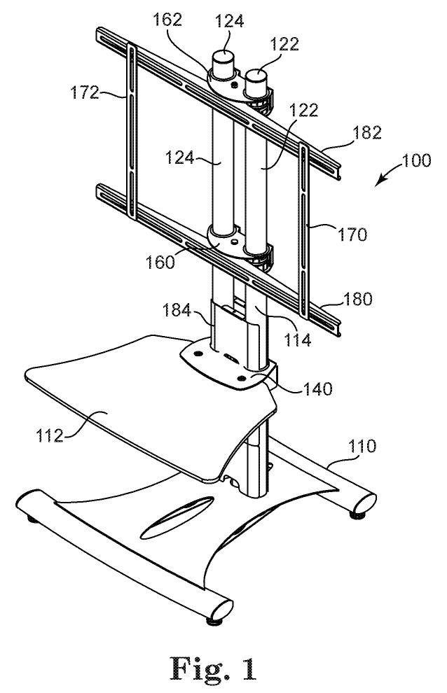

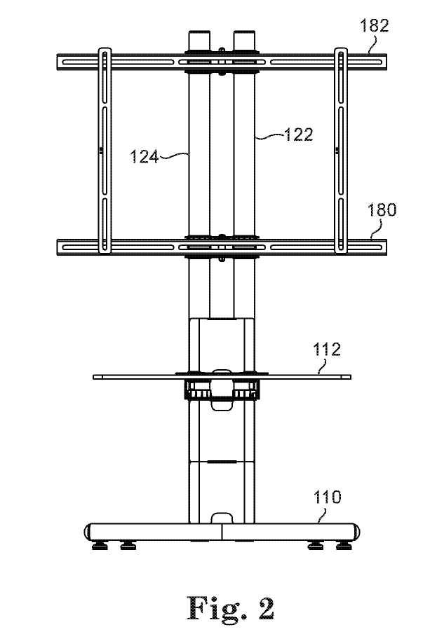

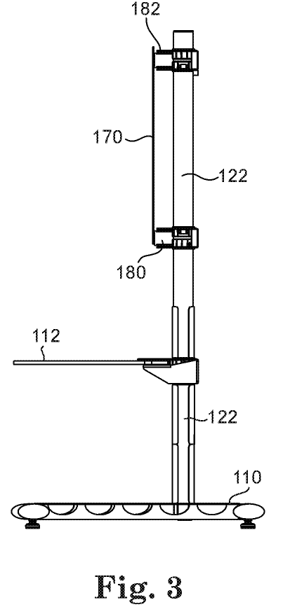

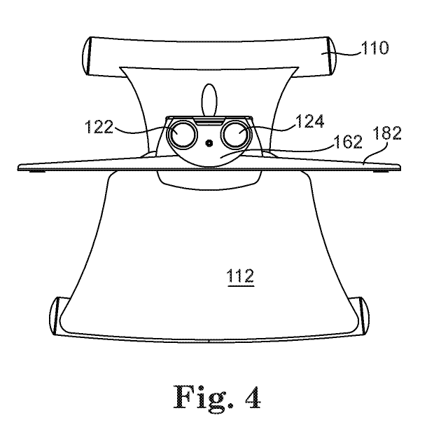

FIG. 1 shows one embodiment of a complete mounting system 100 for supporting a flat panel display (not shown). In this embodiment, a complete floor stand with base 110, slideable shelf 112 and support rods or columns 114 are shown.

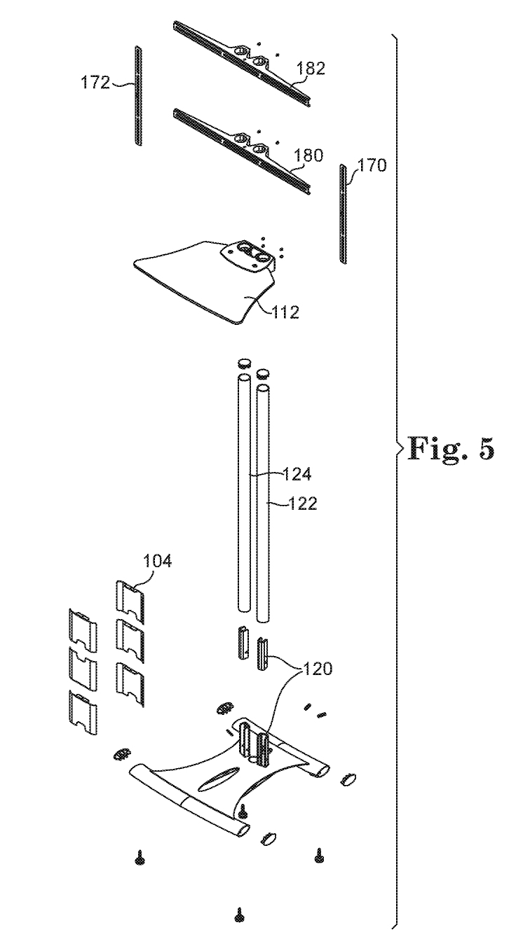

The base 110 includes brackets 120 (FIG. 5) which support rods 122, 124. These rods are cylindrical in this embodiment but they can be any longitudinal member or element. One rod may be used, or for greater strength and resistance to torsion rotation, multiple rods are helpful.

On optional shelf 112 is supported on the rods by a unit 140 which is similar to units 160, 162 as will be described later.

The display panel is supported by a framework of cross members 170, 172 which include slots for connecting to longitudinal units 180, 182.

Plates 184 provide a decorate cover for the rods, where desired.

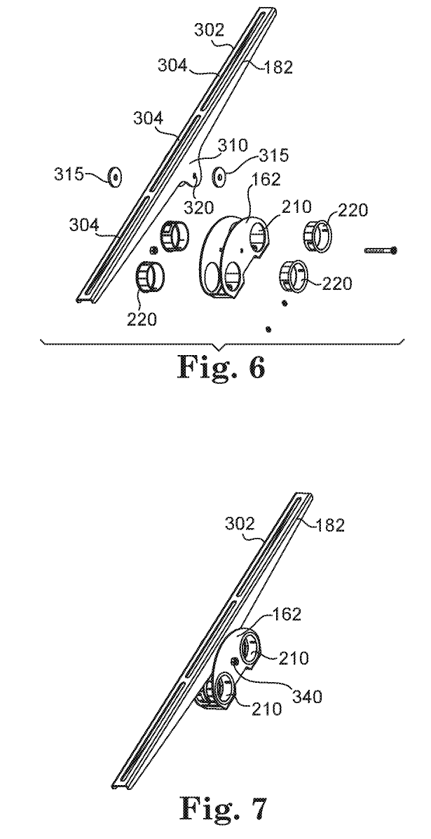

Details of support units 160/162 and 180/182 are shown in greater detail in FIGS. 6, 7, 8, 9, 10 and 11.

Element 180 (182 being identical) include apertures 210 which are sized to be larger than the diameter of rods 122 (or other longitudinal structure of any shape). This allows the elements 180 to slide up or down (i.e. to translate along) the rods. To help prevent slippage during installation, grommet like friction retainer 220 are provided. In the preferred embodiment, these retainers fill the gap between the apertures 210 and the rod diameter and, preferably reduce the aperture size to slightly less than that of the rod diameter. Since they are preferably resilient plastic like material, friction will be created between the rod and element 160. This will create enough friction to slow the movement of elements 160 along the rod. When a display is bolted into place, it is very helpful to have this movement dampened.

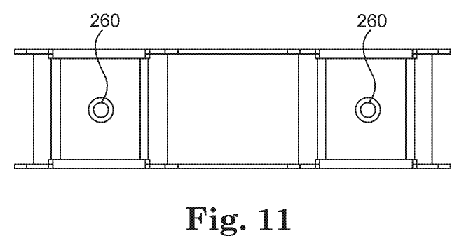

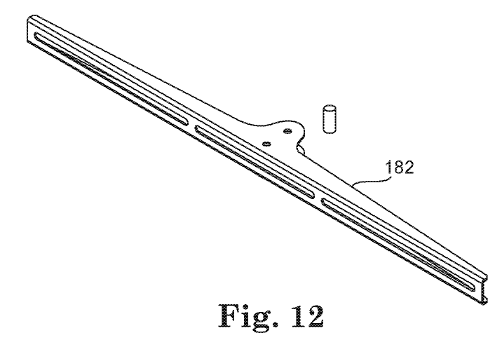

Even with dampening, the friction retainers will only support light weight objects. Therefore, locking devices are provided on elements 160. For example set screws 260 for engagement with the rods are provided in the back plate of the element. (See FIG. 11).

Element 162/162 can take many forms, but the preferred form includes two generally parallel spaced apart plates 290, 292, thereby defining a gap 296. It would be possible to create this gap in a solid element by cutting or milling instead of using discrete plates. The preferred structure has parallel inner walls ready to receive at least part (protrusion 310) of element 180/182. These parallel walls of brackets 180/182 are sized to be received within gap 296 preferably in a snug relationship. Such relationship can be referred to as substantially filling said gap. The objective is to provide minimal play between the plates and gap to minimize the opportunity to twist or torque. There may be spacers 315 inserted therebetween, in which case the spacer should be considered part of the plates to insure that the gap is substantially filled.

Elements 180/182 include a longitudinal section 302 with a plurality of slots 304 which provide locations for bolting to a display/device and the cross members 170, 172. Extending from the rear edge of element 180/182 is a protruding portion 310 which may be at a central location along the element, but it can be offset. This protrusion is used for pivotal connection with element 160/162 and for controlling torsion (twisting) forces between the units.

Aperture 340 in elements 160/162, are to be aligned with like aperture 320 in elements 180/182 with a rod or fastener passing therethrough.

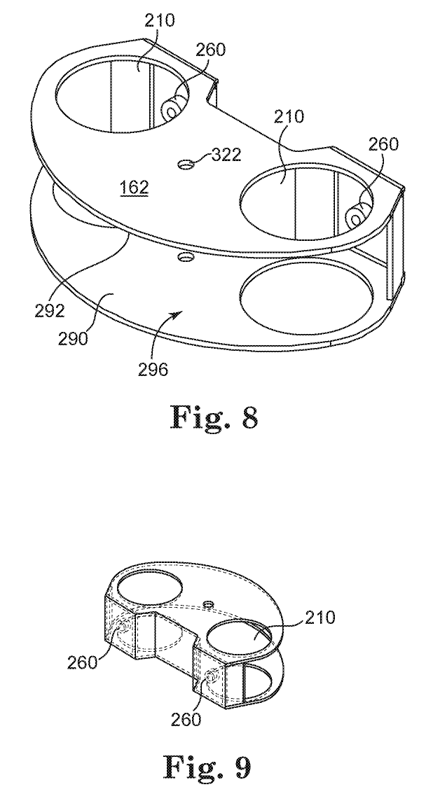

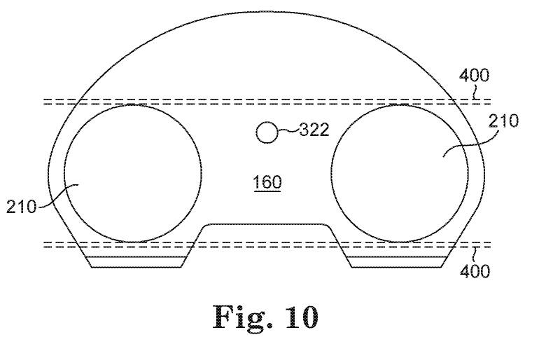

Because the gap 296 between plates 290/292 of element 160/162 is sized to receive (preferably snugly) the protruding portion 310 of element 180/182, the torque of forces tending to twist element with respect to each other is resisted. This can easily occur if the display unit is not perfectly balanced between portions on either side of the pivot point. There are also other sources of imbalance which can cause torque or twisting. The generally parallel spaced apart plates creating the gap and a mating pivoting or other portion prevent this twisting yet allow the display to be rotated as much as 90 degrees in either direction. In the embodiment shown in FIGS. 8, 9 and 10, with the pivot point 322 within the space defined by the rods (if one draws tangent lines 400 in FIG. 10 between the rods thereby defining a space bounded by the tangent lines 400 and the edges of the apertures 210) the rotational extent is limited. Moving this pivot point outside of this boundary and toward the front edge 292, will increase the rotational extent, but will also move the center of gravity of the display system. At some point this can become undesirable. Pivot 322 located as shown toward the tangent lines, causes brackets 180, 182 to impinge the supports 122, 124 (or other element) thereby restricting the rotational movement. This is preferable to prevent the center of gravity to shift too far away from the center of gravity of the base 110.

The resulting structure can be moved translationally (up/down) along the rod element. It will also rotate on the pivot point. All of these movements can be accomplished without moving the base and may only require minor adjustment of stop screws and pivot points. The table 112 can likewise be moved in a manner similar to the display, if desired, or be rotationally fixed as shown in FIG. 5.

As noted above, the present invention is applicable to mounting any device which must be made moveable. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

I claim:

1. A mounting bracket for rotatably mounting a device to a support structure, comprising;
a. a first unit configured to be slideably attached to the support structure; having a pair of substantially planar plates spaced apart a predetermined distance defining a gap, and having a pivot aperture in both of said plates, such that a pivot axis is defined running thru said apertures; and
b. a second unit to be attached to the device, having a substantially planar portion of thickness of not greater than said predetermined distance and configured to be at least partially received between said plates and having an aperture alignable with said pivot apertures and said pivot axis, a configured to be pivotally attached to the surface; so that said second unit may rotate with respect to the first unit on said pivot and while said second unit is substantially prevented from twisting by being captured between said plates of said first unit.

2. The apparatus of claim 1 wherein said second unit includes a protrusion of spaced part substantially parallel plates capable of being received said gap, such that said plates of said first and second unit are substantially maintained in parallel alignment.

3. The apparatus of claim 1 wherein said first unit includes a pair of spaced part receiving apertures and wherein said pivot is located between said receiving apertures.

4. The apparatus of claim 3 wherein said receiving apertures have a predetermined diameter and define a space therebetween bounded by two parallel tangent lines passing parallel to said receiving apertures and wherein said pivot is located in a spaced bounded by said tangent lines and receiving apertures, thereby limiting the rotation of said second unit relative to the first unit.

5. The apparatus of claim 2 wherein said second unit includes a pair of generally parallel plates with a gap therebetween, and wherein said second unit is at least partially received within the said gap.

6. The apparatus of claim 4 wherein the portion of the second unit which is received within said gap generally fills the gap, so that said second unit remains substantially parallel to said plates of said first unit and thereby resists twisting forces between said units.

7. The apparatus of claim 1 further including at least two pairs of first and second units slideably spaced apart along said bracket to support said device at least two locations.

8. A system for rotatably supporting an attachable device comprising;
a. a support structure comprising at least one elongated brackets;
b. a first unit configured to be slideably attached to the support structure; having a pair of substantially planar plates spaced apart a predetermined distance defining a gap, and having a pivot aperture in both of said plates, such that a pivot axis is defined running thru said apertures; and
c. a second unit to be attached to the device, having a substantially planar portion of thickness of not greater than said predetermined distance and configured to be at least partially received between said plates and having an aperture alignable with said pivot apertures and said pivot axis, and configured to be pivotally attached to the surface; so that said second unit may rotate with respect to the first unit on said pivot and while said second unit is substantially prevented from twisting by being captured between said plates of said first unit.

9. The system of claim 8 wherein said at least one support bracket is a plurality of spaced apart cylindrical tubular members and wherein said first unit includes at least two apertures to slideably receive said tubular members.

10. The apparatus of claim 8 wherein said apertures in said plates are lined by friction retainers interposed between said bracket and said first unit.

11. The apparatus of claim 11 wherein said friction retainers are slightly larger than the gap between the plates and the bracket.

12. The apparatus of claim 12 wherein the retainers include a resilient material.

13. A method of mounting a display device on a longitudinal bracket for translational and rotational movement comprising the steps of:
a. mounting a first unit to the bracket in a slideable relationship therewith the bracket, the first unit having a recess with spaced part walls in parallel plans and defining a gap between the walls,
b. mounting a second unit in rotatable relationship with the first unit; said second unit having a portion with spaced part planar walls;
c. capturing at least a portion of the second unit within the gap of the first unit; and
d. attaching a device to said second unit.
